(19) United States
(12) Patent Application Publication
(10) Pub. No.: US 2024/0055867 A1
(43) Pub. Date: Feb. 15, 2024

(54) METHOD AND APPARATUS FOR MATCHING BETWEEN PHOTOVOLTAIC DEVICES, AND PHOTOVOLTAIC TRACKING SYSTEM

(71) Applicant: SUNGROW RENEWABLES DEVELOPMENT CO. LTD., Anhui (CN)

(72) Inventors: Zongjun YANG, Anhui (CN); Shaokun ZOU, Anhui (CN); Yanhu ZHANG, Anhui (CN)

(21) Appl. No.: 18/147,325

(22) Filed: Dec. 28, 2022

(30) Foreign Application Priority Data
Aug. 15, 2022 (CN) 202210976398.7

(51) Int. Cl. H02J 3/38; F24S 50/20

(52) U.S. Cl. CPC H02J 3/381; F24S 50/20; H02S 10/00

(57) ABSTRACT

A method and apparatus for matching between photovoltaic devices, and a photovoltaic tracking system are disclosed. Identifiers of trackers, inverters and MPPT branches in a photovoltaic power station are acquired; a preset action instruction is sent to a target tracker, to instruct the target track to act in response to the preset action instruction; inverter data is obtained after sending the preset action instruction, and an identifier of a target MPPT branch of a target inverter that subjects to an expected MPPT branch change is determined; and the target tracker is mapped to the identifier of the target MPPT branch. The target tracker is determined arbitrarily from the trackers in the photovoltaic power station. Therefore, mapping between the trackers and the MPPT branches can be obtained by applying the method to all the trackers, which has a high matching efficiency and is less error-prone.

### CROSS-REFERENCE TO RELATED APPLICATIONS

This application claims priority to Chinese Patent Application No. 202210976398.7, titled “Method and apparatus for matching between photovoltaic devices, and photovoltaic tracking system”, filed on Aug. 15, 2022 with the China National Intellectual Property Administration, which is incorporated herein by reference in its entirety.

### FIELD OF THE DISCLOSURE

The present disclosure relates to the technical field of photovoltaic power generation, and more particularly, to a method and apparatus for matching between photovoltaic devices, and a photovoltaic tracking system.

### BACKGROUND

A photovoltaic tracking system works with the following principle. There are photovoltaic modules fixed on tracking brackets, and trackers control the tracking brackets to adjust angles of the photovoltaic modules, in order that the photovoltaic modules can receive the maximum radiation. Thereby, a power generation of the photovoltaic system is improved. In order to improve a tracking effect, trackers and various MPPT (Maximum Power Point Tracking) branches of inverters have been linked in the industry in recent years, so as to guide a precise control by the trackers on the tracking brackets based on data feedback from the MPPT branches.

In complex scenes, such as mountain scenes, there are differences in square matrix rectangle, bracket spacing and component height, which may result in a poor control effect if all trackers are controlled uniformly. Therefore, independent control of each tracker is usually adopted. In order to realize independent operations of the branches, it is necessary to perform a one-to-one mapping between the trackers and the MPPT branches of the inverters for establishment of data association after the photovoltaic power station is constructed.

At present, manual manners are mainly adopted to search for identifiers of the trackers, identifiers of the inverters, and identifiers of the MPPT branches, and determine the mapping relationship among the trackers, the inverters, and the MPPT branches based on physical connections there between. However, generally one tracker corresponds to one tracking bracket, one tracking bracket is fixed with one to four photovoltaic modules, and each MPPT branch of an inverter may be connected to several photovoltaic modules. Besides, there are many photovoltaic devices (including the trackers, inverters, and MPPT branches) involved in the photovoltaic power station. Therefore, manually determining the relationship between the photovoltaic devices is inefficient and error-prone.

### SUMMARY

In view of the above, a method and apparatus for matching between photovoltaic devices, and a photovoltaic tracking system are disclosed according to embodiments of the present disclosure, in order to realize an automatic matching between trackers and MPPT branches, so that a matching process is efficient and less error-prone.

A method for matching between photovoltaic devices, applicable to a controller of a photovoltaic tracking system is provided. The method includes: acquiring identifiers of trackers in a photovoltaic power station, identifiers of inverters in the photovoltaic power station, and identifiers of maximum power point tracking, MPPT, branches in the photovoltaic power station; sending a preset action instruction to a target tracker, to instruct the target tracker to act in response to the preset action instruction, where the target tracker is any one of the trackers in the photovoltaic power station, and the preset action instruction carries the identifier of the target tracker; obtaining inverter data after sending the preset action instruction, where the inverter data comprises the identifier of each of the inverters and a changed characteristic of the inverter, and an identifier of each of the MPPT branches and a changed characteristic of the MPPT branch; determining, based on the inverter data, an identifier of a target MPPT branch of a target inverter that subjects to an expected MPPT branch change, where the expected MPPT branch change corresponds to the preset action instruction; and mapping the target tracker to the identifier of the target MPPT branch.

In an embodiment, acquiring the identifiers of the trackers in the photovoltaic power station, the identifiers of the inverters in the photovoltaic power station, and the identifiers of the MPPT branches in the photovoltaic power station includes: sending a broadcast instruction to the trackers and the inverters in the photovoltaic power station, where the broadcast instruction carries an instruction requesting a photovoltaic device to return an identifier of the photovoltaic device; and obtaining the identifiers of the trackers returned from the trackers after receiving the broadcast instruction, and the identifiers of the inverters and the identifiers of the MPPT branches corresponding to the inverters returned from the inverters after receiving the broadcast instruction.

In an embodiment, obtaining the identifiers of the trackers returned from the trackers after receiving the broadcast instruction, and the identifiers of the inverters and the identifiers of the MPPT branches corresponding to the inverters returned from the inverters after receiving the broadcast instruction includes: obtaining an identifier of each of the trackers returned from the tracker with a delay of a first return time since the broadcast instruction is received, and obtaining an identifier of each of the inverters and identifiers of the MPPT branches corresponding to the inverter returned from the inverter with a delay of a second return time since the broadcast instruction is received. The first return time is determined by the tracker using a first random function after receiving the broadcast instruction, and different trackers correspond to a same value or different values of the first return time. The second return time is determined by the inverter using a second random function after receiving the broadcast instruction, and different inverters correspond to a same value or different values of the first return time. The first return time and the second return time are different from each other but are both random.

In an embodiment, in a case that the preset action instruction is to adjust a tracking bracket to an optimal angle, the expected MPPT branch change is an increase of a power or current.

In an embodiment, in a case that the preset action instruction is to adjust a tracking bracket by a preset angle Δθ away from an optimal inclination angle direction, the expected MPPT branch change is a decrease of a power or current.

In an embodiment, in a case that the preset action instruction is to adjust a tracking bracket to a critical angle, the expected MPPT branch change is that a power or current of the MPPT branch becomes the smallest relative to other inverter strings.

In an embodiment, in a case that the preset action instruction is to repeatedly adjust a tracking bracket to a first preset angle, the expected MPPT branch change is a reciprocating change of a power or current.

In an embodiment, in a case that the preset action instruction is to adjust a tracking bracket to a second preset angle at a preset rate, the expected MPPT branch change is a rate that a power or current changes.

In an embodiment, sending the preset action instruction to the target tracker, to instruct the target tracker to act in response to the preset action instruction, includes: determining trackers in a quantity of p from the photovoltaic power station as target trackers, and determining preset action instructions in a quantity of p, where the preset action instructions carry information of different actions, and p is a positive integer; and sending, to each of the target trackers, one of the preset action instructions containing the identifier of the target tracker, to instruct the target tracker to act in response to the preset action instruction.

In an embodiment, sending the preset action instruction to the target tracker, to instruct the target tracker to act in response to the preset action instruction, includes: determining preset action instructions in a quantity of n, where the preset action instructions carry information of different actions and an identifier of at least one tracker, and the preset action instructions include identifiers of m trackers, where m>n, and m represents a total quantity of trackers in the photovoltaic power station, 1<n<Nₘₐₓ, and Nₘₐₓ represents a maximum quantity of available preset action instructions; dividing the trackers in the photovoltaic power station in a way that the target trackers corresponding to a same preset action instruction are in a same group, to obtain tracker groups in a quantity of n; and sending, to each of the target trackers in each of the tracker groups, one of the preset action instructions containing the identifier of the target tracker, to instruct the target tracker to act in response to the preset action instruction, wherein actions instructed by the preset action instructions sent to target trackers in a same tracker group are different from each other.

An apparatus for matching between photovoltaic devices, applicable to a controller of a photovoltaic tracking system, is provided. The apparatus includes: an identifier acquisition unit, configured to acquire identifiers of trackers in a photovoltaic power station, identifiers of inverters in the photovoltaic power station, and identifiers of maximum power point tracking, MPPT, branches in the photovoltaic power station; an instruction sending unit, configured to send a preset action instruction to a target tracker, to instruct the target tracker to act in response to the preset action instruction, where the target tracker is any one of the trackers in the photovoltaic power station, and the preset action instruction carries the identifier of the target tracker; a data acquisition unit, configured to obtain inverter data after sending the preset action instruction, where the inverter data comprises the identifier of each of the inverters and a changed characteristic of the inverter, and an identifier of each of the MPPT branches and a changed characteristic of the MPPT branch; a matching unit, configured to determine, based on the inverter data, an identifier of a target MPPT branch of the target inverter that subjects to an expected MPPT branch change, where the expected MPPT branch change corresponds to the preset action instruction; and a mapping unit, configured to map the target tracker to the identifier of the target MPPT branch.

In an embodiment, the identifier acquisition unit includes: a broadcast instruction sending subunit, configured to send a broadcast instruction to the trackers and the inverters in the photovoltaic power station, where the broadcast instruction carries an instruction requesting a photovoltaic device to return an identifier of the photovoltaic device; and an identifier obtaining subunit, configured to obtain the identifiers of the trackers returned from the trackers after receiving the broadcast instruction, and the identifiers of the inverters and the identifiers of the MPPT branches corresponding to the inverters returned from the inverters after receiving the broadcast instruction.

In an embodiment, the instruction sending unit includes: a selection subunit, configured to determine trackers in a quantity of p from the photovoltaic power station as target trackers, and determine preset action instructions in a quantity of p, wherein the preset action instructions carry information of different actions, and p is a positive integer; and a first action instruction sending subunit, configured to send, to each of the target trackers, one of the preset action instructions containing the identifier of the target tracker, to instruct the target tracker to act in response to the preset action instruction.

In an embodiment, the instruction sending unit includes: an action instruction determination subunit, configured to determine preset action instructions in a quantity of n in total, wherein the preset action instructions carry information of different actions and an identifier of at least one tracker, and the preset action instructions include identifiers of m trackers, where m>n, and m represents a total quantity of trackers in the photovoltaic power station, 1<n<Nₘₐₓ, and Nₘₐₓ represents a maximum quantity of available preset action instructions; a dividing subunit, configured to divide the trackers in the photovoltaic power station in a way that the target trackers corresponding to a same preset action instruction are in a same group, to obtain tracker groups in a quantity of n; and a second action instruction sending unit, configured to send, to each of the target trackers in each of the tracker groups, one of the preset action instructions containing the identifier of the target tracker, to instruct the target tracker to act in response to the preset action instruction, where actions instructed by the preset action instructions sent to target trackers in a same tracker group are different.

A photovoltaic tracking system is further provided, including photovoltaic modules, trackers, inverters and a controller. The controller includes the apparatus as described above. The controller is communicatively connected with the trackers and the inverters, each of the trackers is mechanically coupled to at least one of the photovoltaic modules, and at least one of the photovoltaic modules is connected to a direct current side of one of the inverters.

Based on the technical solutions, a method and apparatus for matching between photovoltaic devices, and a photovoltaic tracking system are disclosed according to embodiments of the present disclosure, with which: identifiers of all trackers, identifiers of all inverters and identifiers of all MPPT branches in a photovoltaic power station are acquired; a preset action instruction is sent to a target tracker, to instruct the target track to act in response to the preset action instruction; inverter data is obtained after sending the preset action instruction, and an identifier of a target MPPT branch of a target inverter that subjects to an expected MPPT branch change is determined; and the target tracker is mapped to the identifier of the target MPPT branch. Since the target tracker is determined arbitrarily from the trackers in the photovoltaic power station, mapping between all the trackers in the photovoltaic power station and all the MPPT branches in the photovoltaic power station can be obtained by applying the method to all the trackers in the photovoltaic power station. According to the embodiments of the present disclosure, the inverter is controlled to perform the corresponding action in response to the preset action instruction; after the tracker completes the action, the MPPT branch that subjects to the expected MPPT branch change is determined, and an automatic matching between the tracker and the MPPT branch is realized. The process does not require manual participation, has a high matching efficiency, and is less error-prone.

### BRIEF DESCRIPTION OF THE DRAWINGS

In order for a clearer illustration of technical solutions in embodiments of the present disclosure or the conventional technology, drawings used in the description of the embodiments or the conventional technology are described briefly hereinafter. Apparently, the drawings described in the following illustrate only some embodiments of the present disclosure, and other drawings may be obtained by those ordinarily skilled in the art based on these drawings without any creative effort.

FIG. 1 is a schematic structural diagram of a photovoltaic tracking system according to an embodiment of the present disclosure.

FIG. 2 is a flowchart of a method for matching between photovoltaic devices according to an embodiment of the present disclosure.

FIG. 3 is a schematic diagram showing a situation where a preset action instruction is to adjust a tracking bracket to an optimal angle according to an embodiment of the present disclosure.

FIG. 4 is a schematic diagram of mapping between trackers and MPPT branches in a power station according to an embodiment of the present disclosure.

FIG. 5 is a schematic diagram showing a process of batch matching by groups according to an embodiment of the present disclosure.

FIG. 6 is a schematic diagram showing a process of batch matching by groups according to another embodiment of the present disclosure.

FIG. 7 is a schematic structural diagram of an apparatus for matching between photovoltaic devices according to an embodiment of the present disclosure.

### DETAILED DESCRIPTION

Hereinafter technical solutions in the embodiments of the present disclosure are described clearly and completely in conjunction with the drawings of the embodiments of the disclosure. It is apparent that the described embodiments are only some, rather than all, embodiments of the present disclosure. Any other embodiment obtained by those skilled in the art based on the embodiments in the present disclosure without any creative effort shall fall within the protection scope of the present disclosure.

A method and apparatus for matching between photovoltaic devices, and a photovoltaic tracking system are disclosed according to embodiments of the present disclosure, with which: identifiers of all trackers, identifiers of all inverters and identifiers of all MPPT branches in a photovoltaic power station are acquired; a preset action instruction is sent to a target tracker, to instruct the target track to act in response to the preset action instruction; inverter data is obtained after sending the preset action instruction, and an identifier of a target MPPT branch of a target inverter that subjects to an expected MPPT branch change is determined; and the target tracker is mapped to the identifier of the target MPPT branch. Since the target tracker is determined arbitrarily from the trackers in the photovoltaic power station, mapping from any of all the trackers in the photovoltaic power station to the MPPT branches in the photovoltaic power station can be obtained by applying the method to each of the trackers in the photovoltaic power station. According to the embodiments of the present disclosure, the inverter is controlled to perform the corresponding action in response to the preset action instruction; after the tracker completes the action, the MPPT branch that subjects to the expected MPPT branch change is determined, and an automatic matching between the tracker and the MPPT branch is realized. The process does not require manual participation, has a high matching efficiency, and is less error-prone.

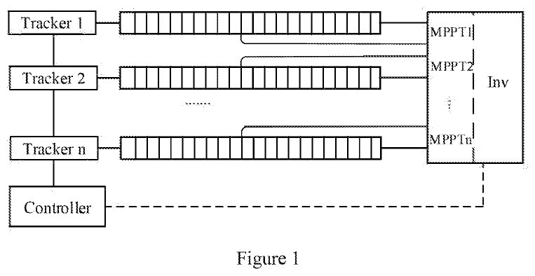

To facilitate understanding of working principles of matching between photovoltaic devices, a schematic structural diagram of a photovoltaic tracking system according to an embodiment of the present disclosure is illustrated in FIG. 1. The photovoltaic tracking system includes a controller, photovoltaic modules, trackers, and an inverter.

The controller is communicatively connected to the trackers and the inverter, through RS485 or wireless, for example. The controller can obtain operation data of the inverter, perform analysis and calculations, and issue instructions to the trackers. In practice, the controller may be embedded into the trackers and the inverter, or may be mounted independently.

Each tracker is connected with at least one of the photovoltaic modules through a mechanical structure, and can automatically adjust an angle of the photovoltaic module, so as to change an output power or current data of the photovoltaic module. In a case where multiple photovoltaic modules are arranged as a photovoltaic array (see FIG. 1 for the photovoltaic array between the trackers and the inverters), the trackers is connected to the photovoltaic array through a mechanical structure. In a case of multiple photovoltaic arrays, the multiple photovoltaic arrays are electrically connected to each other, and the trackers can automatically adjust the angle of each of the photovoltaic arrays, so as to change radiation received by a surface of each photovoltaic module in the photovoltaic array.

A direct current side of the inverter is connected to at least one of the photovoltaic modules. In a case of multiple photovoltaic modules, photovoltaic strings, formed of photovoltaic modules that are electrically connected in series, are connected in parallel to the direct current side of the inverter.

In order to realize independent operation of branches, it is necessary to perform a one-to-one mapping between the trackers and the MPPT branches of the inverter. That is, as shown in FIG. 1, the n trackers and the n MPPT branches of the inverter are mapped in one-to-one association.

In order to solve problems of low efficiency and fallibility due to manual determination of a relationship between photovoltaic devices (including trackers, inverters and MPPT branches) in the conventional technology, a method is proposed according to an embodiment of the present disclosure and is described below.

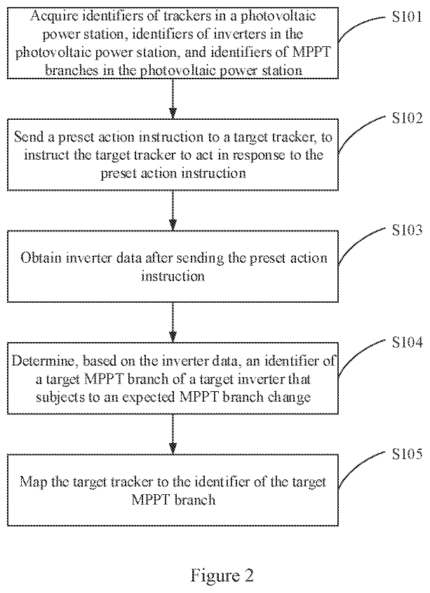

FIG. 2 illustrates a flowchart of a method for matching between photovoltaic devices according to an embodiment of the present disclosure. The method is applicable to the controller of the photovoltaic tracking system as shown in FIG. 1. As shown in FIG. 2, the method includes steps S101 to S105.

In step S101, identifiers of all trackers, identifiers of all inverters, and identifiers of all MPPT branches in the photovoltaic power station are acquired.

An identifier refers to a number, symbol, text, or the like, assigned to a thing or concept according to a certain regulation, so as to be easily recognized and processed by a human or machine.

In an embodiment, each of the trackers is assigned with a unique identifier, hereinafter referred to as a tracker identifier, which identifies the tracker during communication. An example of a tracker identifier may be, for example, an ID, a numbering, or the like, such as “tracker 4”.

Each of the inverters and each of the MPPT branches of the inverter are also assigned with unique identifiers, which identify the inverter or the MPPT branch during communication, respectively. For example, an Inverter 3-MPPT2 represents the No. 2 MPPT branch of the No. 3 inverter. The identifier of the inverter or the MPPT branch of the inverter may be alternatively represented by ID numbers, which is specifically determined based on an actual need, and is not limited in the present disclosure.

In practice, an identifier of an inverter and an identifier of an MPPT branch may be combined into an inverter-MPPT combined identifier.

In step S102, a preset action instruction is sent to a target tracker, to instruct the target tracker to act in response to the preset action instruction.

The target tracker is any of the trackers in the photovoltaic power station, and the preset action instruction carries the identifier of the target tracker.

In practice, the target tracker is determined arbitrarily from the trackers of the photovoltaic power station, and the preset action instruction includes the identifier of the target tracker and information of an action that the target tracker is required to perform.

In step S103, inverter data is obtained after sending the preset action instruction.

The inverter data includes an identifier and changed characteristic of each of the inverters, and an identifier and changed characteristic of each of the MPPT branches.

The changed characteristic of the inverter and the changed characteristic of the MPPT branch include, but are not limited to, power, current, and the like.

In step S104, an identifier of a target MPPT branch of a target inverter that subjects to an expected MPPT branch change is determined, based on the inverter data.

The expected MPPT branch change corresponds to the preset action instruction.

The expected MPPT branch change refers to an expected change that is predicted by the controller based on the preset action instruction to occur in a MPPT branch that forms a mapping relationship with the target inverter. In an example, after the preset action instruction is sent to the target tracker, the MPPT branch that is in a mapping relationship with the target inverter may subject to an expected change corresponding to the preset action instruction. Based on this, an identifier of the target MDPT branch of the target inverter that subjects to the expected MPPT branch change may be determined from the inverter data.

In step S105, the target tracker is mapped to the identifier of the target MPPT branch.

In an embodiment, the target tracker is determined arbitrarily from the trackers of the photovoltaic power station. With the method being applied to all the trackers in the photovoltaic power station, the mapping between any of all the trackers in the photovoltaic power station and the MPPT branches in the photovoltaic power station may be obtained.

Based on the above, a method for matching between photovoltaic devices is disclosed according to the embodiments of the present disclosure. With the method, identifiers of all trackers, identifiers of all inverters and identifiers of all MPPT branches in a photovoltaic power station are acquired; a preset action instruction is sent to a target tracker, to instruct the target track to act in response to the preset action instruction; inverter data is obtained after sending the preset action instruction; an identifier of a target MPPT branch of a target inverter that subjects to an expected MPPT branch change is determined based on the inverter data; and the target tracker is mapped to the identifier of the target MPPT branch. Since the target tracker is determined arbitrarily from the trackers in the photovoltaic power station, mapping between all the trackers in the photovoltaic power station and all the MPPT branches in the photovoltaic power station can be obtained by applying the method to all the trackers in the photovoltaic power station. According to the embodiments of the present disclosure, the inverter is controlled to perform the corresponding action in response to the preset action instruction; after the tracker completes the action, the MPPT branch that subjects to the expected MPPT branch change is determined, and an automatic matching between the tracker and the MPPT branch is realized. The process does not require manual participation, has a high matching efficiency, and is less error-prone.

The step S101 of acquiring identifiers of all the trackers, identifiers of all the inverters and identifiers of all the MPPT branches in the photovoltaic power station mentioned in the above embodiments may be implemented through the following two manners.

A first manner is manual entry. That is, the identifiers of the trackers, identifiers of the inverters, and the identifiers of the MPPT branches are written into a controller of a photovoltaic tracking system conforming to certain file format.

However, the manual entry manner is time-consuming, labor-intensive, and error-prone. Based on this, a convenient manner of automatic entry is provided according to an embodiment of the present disclosure.

Therefore, step S101 may specifically include:
(1) Sending a broadcast instruction to all the trackers and the inverters in the photovoltaic power station, where the broadcast instruction carries an instruction requesting a photovoltaic device to return an identifier of the photovoltaic device; and
(2) Obtaining the identifiers returned from the trackers after receiving the broadcast instruction, and the identifiers of the inverters and the identifiers of the MPPT branches corresponding to the inverters returned from the inverters after receiving the broadcast instruction.

In an example, the controller sends the broadcast instruction to each of the trackers and the inverters in the photovoltaic power station, and the broadcast instruction carries an instruction requesting a photovoltaic device to return its identifier. That is, each tracker is required to send its identifier to the controller in response to the broadcast instruction, and each inverter is required to send its identifier, together with identifiers of any MPPT branch connected to the inverter, to the controller in response to the broadcast instruction.

In order to ensure, as much as possible, that the multiple trackers and the multiple inverters return their identifiers at different time instants from each other, so as to avoid communication congestion caused by all photovoltaic devices uploading their identifiers simultaneously, the step of obtaining the identifiers returned from the trackers after receiving the broadcast instruction, and the identifiers of the inverters and the identifiers of the MPPT branches corresponding to the inverters returned from the inverters after receiving the broadcast instruction specifically includes:
obtaining the identifier of each of the trackers returned from the trackers with a delay of a first return time since the broadcast instruction is received, and an identifier of each of the inverters and an identifier of the MPPT branches corresponding to the inverter returned from the inverter with a delay of a second return time since the broadcast instruction is received.

The first return time is determined by the tracker through a first random function after receiving the broadcast instruction. Different trackers correspond to a same value or different values of the first return time.

The second return time is determined by the inverter through a second random function after receiving the broadcast instruction. Different inverters correspond to a same value or different values of the second return time.

The first return time and the second return time are different but both random.

According to embodiments of the present disclosure, the following solution is adopted in order to realize different time instants when the trackers and the inverters return their identifiers, so as to avoid communication congestion caused by all photovoltaic devices uploading their identifiers simultaneously. After receiving the broadcast instruction, each of the trackers determines a first return time Δt1 using a first random function, and returns its identifier after waiting for the first return time Δt1. Values of the first return time Δt1 determined by the trackers may be the same or different, as long as avoiding multiple trackers returning their identifiers simultaneously.

Similarly, after receiving the broadcast instruction, each of the inverters determines a second return time Δt2 using a second random function, and return its identifier after waiting for the second return time Δt2. Values of the second return time Δt2 determined by the inverters may be the same or different, as long as avoiding multiple inverters returning their identifiers simultaneously.

Similarly, the first return time Δt1 and the second return time Δt2 should be different from each other, so as to realize that the trackers and the inverters return their identifiers at different time instants.

With either the manual entry or the automatic entry, the controller of the photovoltaic tracking system finally obtains two data sheets. One of the two data sheets records inverter-MPPT combined identifiers, each of which is composed of an identifier of an inverter and an identifier of an MPPT. A basic form of the data sheet is as shown in Table 1 below:

TABLE 1

Inverter-MPPT combined identifiers:
INV1-MPPT1
INV1-MPPT2
INV1-MPPT3
INV2-MPPT1
INV2-MPPT2
INV2-MPPT3
INV3-MPPT1
INV3-MPPT2
. . .

INV in Table 1 is abbreviation of inverter.

Another one of the two data sheets records identifiers of the trackers. A basic form of the data sheet is as shown in Table 2 below:

TABLE 2

Identifiers of trackers:
Tracker 3
Tracker 4
Tracker 6
Tracker 1
Tracker 2
Tracker 9
Tracker 5
Tracker 8
. . .

It should be noted that the data in table 1 and data in table 2 are independent from each other at present, without any mapping there between.

It should be noted that in an embodiment of the present disclosure, there are various types of preset action instructions sent to the target tracker, and different preset action instructions correspond to different actions. Accordingly, there are different types of expected MPPT branch changes, which are listed below.

(1) In a case where the preset action instruction is to adjust a tracking bracket to an optimal angle, correspondingly the expected MPPT branch change is an increase of a power or current.

When the preset action instruction sent to the target tracker is to adjust a tracking bracket to an optimal angle, the expected change of a corresponding MPPT branch is an increase of a power or current, while the power or current of the MPPT branches of other inverters change within a normal range.

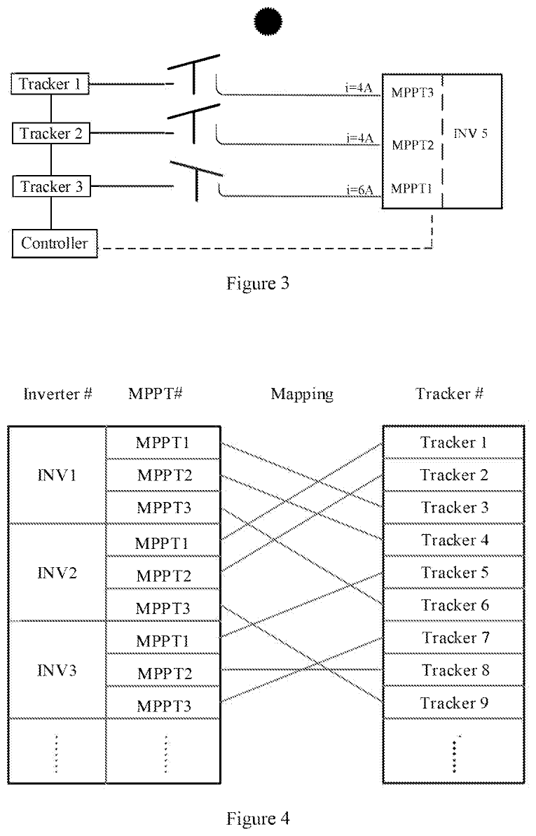

Reference is made to FIG. 3, which is a schematic diagram showing a situation where a preset action instruction is to adjust a tracking bracket to an optimal angle according to an embodiment of the present disclosure. FIG. 3 demonstrates specific actions and a determination process. It is assumed that among Tracker 1, Tracker 2, and Tracker 3, the Tracker 3 is randomly determined as a target tracker. The controller sends a preset action instruction to the Tracker 3, and the Tracker 3 adjusts a tracking bracket to a best angle. After the adjustment is finished, an expected change of an MPPT branch corresponding to the Tracker 3 is that a current of the MPPT branch becomes greater than that of other strings. For example, a detected current of Inverter5-MPPT1 is 6A, while currents of other branches, such as Inverter5-MPPT2 and Inverter5-MPPT3, are basically unchanged at such as 4A. In such case, it may be determined that a mapping relationship existing between Tracker 3 and Inverter5-MPPT1.

(2) In a case where the preset action instruction is to displace a tracking bracket from an optimal inclination direction by a preset angle Δθ, correspondingly the expected MPPT branch change is a decrease of a power or current.

When the preset action instruction sent to the target tracker is to displace a tracking bracket from an optimal inclination direction of the tracking bracket by a preset angle Δθ, that is, to displace the tracking bracket in an direction opposite to the optimal inclination direction by the preset angle Δθ, the expected change of a corresponding MPPT branch is a decrease of a power or current, while the power or current of the MPPT branches of other inverters change within a normal range.

(3) In a case where the preset action instruction is to adjust a tracking bracket to a critical angle, correspondingly the expected MPPT branch change is that a power or current of the MPPT branch becomes the smallest relative to other inverter strings.

The critical angle refers to a protective angle or limiting angle set for the tracking bracket.

When the preset action instruction sent to the target tracker is to adjust a tracking bracket to a critical angle, such as −60° or 60°, the expected change of a corresponding MPPT branch is that a power or current of the MPPT branch becomes the smallest relative to other inverter strings.

(4) In a case where the preset action instruction is to repeatedly adjust a tracking bracket to a first preset angle, correspondingly the expected MPPT branch change is a reciprocating change of a power or current.

When the preset action instruction sent to the target tracker is to repeatedly adjust a tracking bracket to a first preset angle, the target tracker is dynamically adjusted. That is, the tracking bracket is first adjusted to the first preset angle along a direction, and then adjusted reversely, which may result in two cases. In case 1, the tracking bracket is first adjusted toward an optimal inclination direction, and then adjusted toward a reverse direction. In such case, the expected change of an MPPT branch is that a power or current first increases and then decreases. In case 2, the tracking bracket is first adjusted away from the optimal inclination direction, and then adjusted reversely. In such case, the expected MPPT branch change is that the power or current first decreases and then increases. It can be seen from the above that when the preset action instruction is to repeatedly adjust the tracking bracket to the first preset angle, the expected change of the corresponding MPPT branch is a reciprocating change of a power or current, while the power or current of MPPT branches of other inverters change within a normal range.

(5) In a case where the preset action instruction is to adjust a tracking bracket to a second preset angle at a preset rate, correspondingly the expected MPPT branch change is a rate that a power or current changes.

When the preset action instruction sent to the target tracker is to adjust a tracking bracket to a second preset angle at a preset rate, the expected change of a corresponding MPPT branch is that a power or current changes rapidly, while the power or current of the MPPT branches of other inverters does not change or changes slowly. Therefore, in a case that multiple trackers are adjusted at a same time, the MPPT branch of the inverter corresponding to the target tracker may be determined based on expected change rates of the MPPT branch of the inverter.

It should be noted that the preset action instruction includes but is not limited to the above-mentioned five types.

A process of matching between photovoltaic devices according to the present disclosure is described referring to an example in which each inverter in a photovoltaic power station corresponds to three MPPT branches. For example, an inverter INV1 corresponds to an MPPT1, an MPPT2 and an MPPT3. According to the steps shown in FIG. 2, the preset action instruction is to displace a tracking bracket from an optimal inclination direction of the tracking bracket by a preset angle Δθ, one-to-one mapping between trackers and the MPPT branches is determined, and finally mappings between all the trackers and all the MPPT branches are determined, as shown in FIG. 4. Thereafter, when the photovoltaic power station is in normal operation, a certain tracker may be specified to adjust its angle based on data collected by a corresponding MPPT branch, so that a tracking process is optimized.

In a case of 2P-type tracking brackets combined with string inverters, one tracking bracket may be provided with 4 photovoltaic modules and corresponds to 2 MPPT branches. A matching result in this case is shown in table 3, in which one tracker corresponds to two MPPT branches.

TABLE 3

| Inverter identifier-MPPT identifier | Tracker identifier |
|---|---|
| INV1-MPPT1 | Tracker 1 |
| INV1-MPPT2 | |
| INV1-MPPT3 | Tracker 4 |
| INV1-MPPT4 | |
| INV2-MPPT1 | Tracker 2 |
| INV2-MPPT2 | |
| INV2-MPPT3 | Tracker 3 |
| INV2-MPPT4 | |

In a case of a centralized power station, an inverter has a large capacity, but has a less quantity of MDPT branches, for example, no more than 4 MPPT branches. A matching result in this case is shown in table 4, in which multiple trackers correspond to one MPPT branch.

TABLE 4

| Inverter identifier-MPPT identifier | Tracker identifier |
|---|---|
| INV1-MPPT1 | Tracker 3 |
| | Tracker 4 |
| | Tracker 6 |
| | . . . |
| | Tracker 18 |
| INV1-MPPT2 | Tracker 9 |
| | Tracker 5 |
| | Tracker 8 |
| | . . . |
| | Tracker 17 |

It should be noted that the automatic matching processes in table 3 and table 4 are implemented by specifying one tracker each time and sending one preset action instruction. However, an actual photovoltaic power station has a large capacity and a large quantity of photovoltaic devices, and determining mapping between the photovoltaic devices one by one is inefficient. Therefore, in order to improve a matching efficiency, a batch matching process is further provided according to embodiments of the present disclosure, which is described below.

To further optimize the above embodiments, step S102 may specifically include:
determining target trackers in a quantity of p from the photovoltaic power station, and determine preset action instructions in a quantity of p, where the preset action instructions carry information of different actions, and p is a positive integer; and
sending, to each of the trackers, one of the p preset action instructions carrying the identifier of the tracker, to instruct the target tracker to act in response to the preset action instruction.

An example is described below. It is assumed that p=5, that is, five target trackers are determined from the trackers in the photovoltaic power station, and five preset action instructions carrying information of different actions and identifiers of different trackers are issued simultaneously, such that each of the target trackers acts in response to corresponding one of the preset action instructions. Thereby, identifiers of the target MPPT branches that satisfy respective expected MPPT branch changes may be determined from all the MPPT branches, so as to realize mapping between five target trackers and identifiers of five MPPT branches through a single round.

In addition to the above-mentioned manner, the preset action instructions may be issued in batches.

In order to further optimize the above embodiments, step S102 may specifically include the following steps (1) to (3).

In step (1), n preset action instructions are determined.

The preset action instructions carry information of different actions. Each of the preset action instructions includes at least one tracker identifier, and the n preset action instructions contain m tracker identifiers in total, where m>n, m represents a total quantity of trackers in the photovoltaic power station, 1<n<Nₘₐₓ and Nₘₐₓ represents a maximum quantity of available preset action instructions.

In step (2), the trackers in the photovoltaic power station are divided in a way that target trackers corresponding to a same preset action instruction are in a same group, obtaining n tracker groups.

In step (3), for each of the target trackers in each of the tracker groups, a preset action instruction containing the identifier of the target tracker is sent to the target tracker, to instruct the target tracker to act in response to the preset action instruction.

Actions instructed by the preset action instructions sent to target trackers in a same tracker group are different from each other.

In this embodiment, based on n preset action instructions carrying information of different actions, all trackers in the photovoltaic power station are firstly divided into n groups. Then, for each of the target trackers in each of the groups, a preset action instruction containing an identifier of the target tracker is sent to the target tracker, to instruct the target tracker to act in response to the preset action instruction. Thereby, a mapping between the target trackers and the MPPT branches within each of the groups is further refined, and a unique mapping between all the MPPT branches and the target trackers is finally determined after several rounds.

It can be seen that matching in batches and by groups in parallel can significantly reduce the time for matching between photovoltaic devices, so that a mapping between the target trackers and the MPPT branches can be determined quickly.

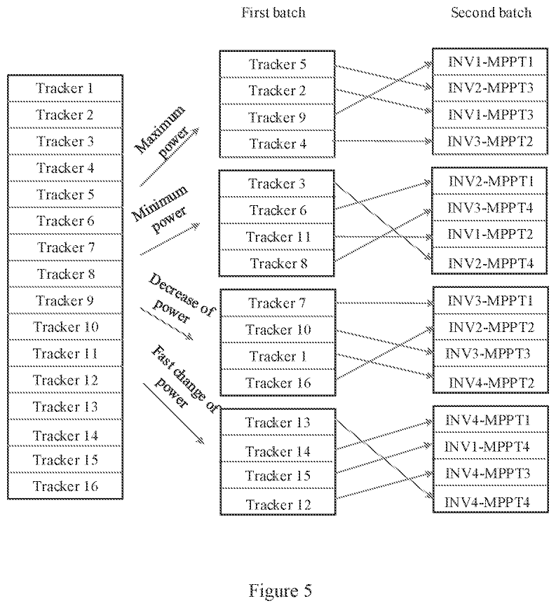

For a better understanding of the manner of batching and grouping, an example is given below. Reference is made to FIG. 5, which is a schematic diagram of a process of matching in batches and by groups according to an embodiment of the present disclosure. It is assumed that there are 16 trackers, and 4 preset action instructions carrying information of different actions are determined as a first batch of instructions to be sent to the trackers. Each of the preset action instructions includes identifiers of four trackers, and the 16 trackers may be divided into four groups.

A first group includes Tracker 5, Tracker 2, Tracker 9, and Tracker 4. An expected change of an MPPT branch corresponding to the four trackers in the first group is that a power becomes the maximum.

A second group includes Tracker 3, Tracker 6, Tracker 11, and Tracker 8. An expected change of an MPPT branch corresponding to the four trackers in the second group is that a power becomes the minimum.

A third group includes Tracker 7, Tracker 10, Tracker 1, and Tracker 16. An expected change of an MPPT branch corresponding to the four trackers in the third group is that a power becomes smaller.

A fourth group includes Tracker 13, Tracker 14, Tracker 15, and Tracker 12. An expected change of an MPPT branch corresponding to the four trackers in the fourth group is that a power changes quickly.

Since the trackers in a same group cannot uniquely determine corresponding MPPT branches, a second batch of preset action instructions is then issued. As each group contains four trackers, four preset action instructions carrying information of different actions are determined as the second batch of instructions. The four preset action instructions are sent to the four trackers in a same group according to the tracker identifiers contained in the instructions, to instruct each of the target trackers to act in response to the received preset action instruction. Actions instructed by the preset action instructions sent to target trackers in a same tracker group are different from each other, so that a mapping between the trackers and the MPPT branches is determined within a group.

It can be seen from the above that with the batching manner, all trackers and all MPPT branches are matched through only two steps.

In the above embodiments, the quantity m of the trackers is an integral multiple of the quantity n of the preset action instructions, and therefore the trackers may be evenly grouped. In practice, it is also possible to group trackers unevenly.

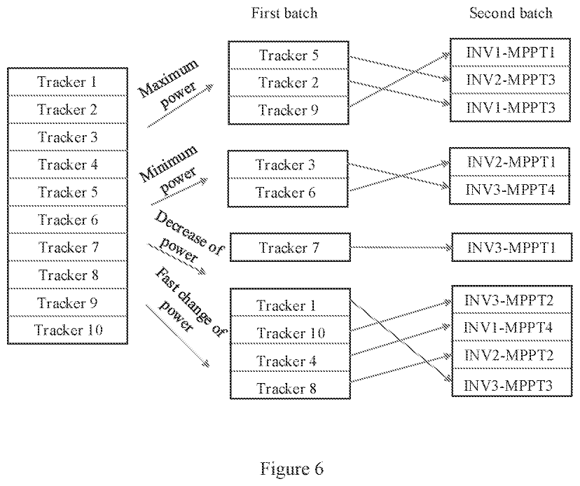

Reference is made to FIG. 6, which is a schematic diagram of a process of matching in batches and by groups according to another embodiment of the present disclosure. It is assumed that there are 10 trackers, and 4 preset action instructions carrying information of different actions are determined as a first batch of instructions to be sent in a first round. Due to a fact that the trackers cannot be grouped evenly, the preset action instructions may correspond to different numbers of trackers. FIG. 6 shows four groups.

A first group includes Tracker 5, Tracker 2, and Tracker 9. An expected change of an MPPT branch corresponding to the three trackers in the first group is that a power becomes the maximum.

A second group includes Tracker 3 and Tracker 6. An expected change of an MPPT branch corresponding to the two trackers in the second group is that a power becomes the minimum.

A third group includes Tracker 7. An expected change of an MPPT branch corresponding to the tracker in the third group is a decrease of a power.

A fourth group includes Tracker 1, Tracker 10, Tracker 4, and Tracker 8. An expected change of an MPPT branch corresponding to the four trackers in the fourth group is that a power changes quickly.

Since the trackers in a same group cannot uniquely determine corresponding MPPT branches, a second batch of preset action instructions is then issued. Corresponding quantity of preset action instructions are determined based on the number of trackers contained in each group, as the second batch of instructions to be sent. The preset action instructions are sent to the trackers in a same group according to the tracker identifiers contained in the instructions, to instruct each of the target trackers to act in response to the received preset action instruction. Actions instructed by the preset action instructions sent to target trackers in a same tracker group are different from each other, so that a mapping between the trackers and the MPPT branches is determined within a group.

Corresponding to the above method embodiments, an apparatus for matching between photovoltaic devices is further provided in the present disclosure.

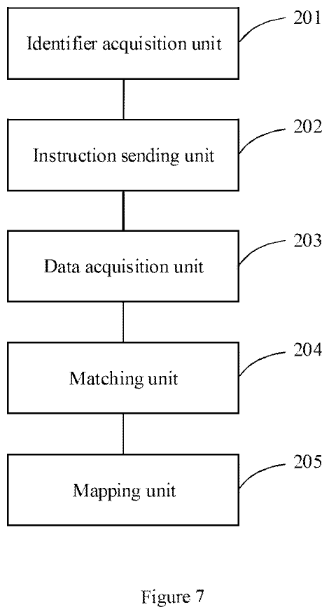

Reference is made to FIG. 7, which is a schematic structural diagram of an apparatus for matching between photovoltaic devices according to an embodiment of the present disclosure. The apparatus is applicable to a controller of the photovoltaic tracking system as shown in FIG. 1. The apparatus includes an identifier acquisition unit 201, an instruction sending unit 202, a data acquisition unit 203, a matching unit 204, and a mapping unit 205.

The identifier acquisition unit 201 is configured to acquire identifiers of all trackers in a photovoltaic power station, identifiers of all inverters in the photovoltaic power station, and identifiers of all MPPT branches in the photovoltaic power station.

In an embodiment, each of the trackers is assigned with a unique identifier, hereinafter referred to as a tracker identifier, which identifies the tracker during communication. An example of a tracker identifier may be, for example, an ID, a numbering, or the like, such as “tracker 4”.

Each of the inverters and each of the MPPT branches of the inverter are also assigned with unique identifiers, which identify the inverter or the MPPT branch during communication, respectively. For example, an Inverter 3-MPPT2 represents the No. 2 MPPT branch of the No. 3 inverter. The identifier of the inverter or the MPPT branch of the inverter may be alternatively represented by ID numbers, which is specifically determined based on an actual need, and is not limited in the present disclosure.

In practice, an identifier of an inverter and an identifier of an MPPT branch may be combined into an inverter-MPPT combined identifier.

The instruction sending unit 202 is configured to send a preset action instruction to a target tracker, to instruct the target tracker to act in response to the preset action instruction. The target tracker is any of the trackers in the photovoltaic power station, and the preset action instruction carries the identifier of the target tracker.

In practice, the target tracker is determined arbitrarily from the trackers of the photovoltaic power station, and the preset action instruction includes the identifier of the target tracker and information of an action that the target tracker is required to perform.

The data acquisition unit 203 is configured to obtain inverter data after the instruction sending unit 202 sends the preset action instruction. The inverter data includes the identifier and changed characteristic of each of the inverters, and an identifier and changed characteristic of each of the MPPT branches.

The matching unit 204 is configured to determine, based on the inverter data, an identifier of a target MPPT branch of a target inverter that subjects to an expected MPPT branch change. The expected MPPT branch change corresponds to the preset action instruction.

After the target tracker acts in response to the preset action instruction, the MPPT branch that is in a mapping relationship with the target inverter may subject to an expected change corresponding to the preset action instruction. Based on this, an identifier of the target MPPT branch of the target inverter that subjects to the expected MPPT branch change may be determined from the inverter data.

The mapping unit 205 is configured to map the target tracker to the identifier of the target MDPT branch.

In an embodiment, the target tracker is determined arbitrarily from the trackers of the photovoltaic power station. With the method being applied to all the trackers in the photovoltaic power station, the mapping between all the trackers in the photovoltaic power station and the MPPT branches in the photovoltaic power station may be obtained.

Based on the above, an apparatus for matching between photovoltaic devices is disclosed according to the embodiments of the present disclosure. With the apparatus, identifiers of all trackers, identifiers of all inverters and identifiers of all MPPT branches in a photovoltaic power station are acquired; a preset action instruction is sent to a target tracker, to instruct the target track to act in response to the preset action instruction; inverter data is obtained after sending the preset action instruction; an identifier of a target MPPT branch of a target inverter that subjects to an expected MPPT branch change is determined based on the inverter data; and the target tracker is mapped to the identifier of the target MPPT branch. Since the target tracker is determined arbitrarily from the trackers in the photovoltaic power station, mapping between all the trackers in the photovoltaic power station and all the MPPT branches in the photovoltaic power station can be obtained by applying the method to all the trackers in the photovoltaic power station. According to the embodiments of the present disclosure, the inverter is controlled to perform the corresponding action in response to the preset action instruction; after the tracker completes the action, the MPPT branch that subjects to the expected MPPT branch change is determined, and an automatic matching between the tracker and the MPPT branch is realized. The process does not require manual participation, has a high matching efficiency, and is less error-prone.

To further optimize the above embodiment, the identifier acquisition unit 201 may include a broadcast instruction sending subunit and an identifier obtaining subunit.

The broadcast instruction sending subunit is configured to send a broadcast instruction to all the trackers and the inverters in the photovoltaic power station. The broadcast instruction carries an instruction requesting a photovoltaic device to return an identifier of the photovoltaic device.

The identifier obtaining subunit is configured to obtain the identifiers of the trackers returned from the trackers after receiving the broadcast instruction, and the identifiers of the inverters and the identifiers of the MPPT branches corresponding to the inverters returned from the inverters after receiving the broadcast instruction.

In order to ensure, as much as possible, that the multiple trackers and the multiple inverters return their identifiers at different time instants from each other, so as to avoid communication congestion caused by all photovoltaic devices uploading their identifiers simultaneously, the identifier obtaining subunit can be specifically configured to: obtain the identifier of each of the trackers returned from the tracker with a delay of a first return time since the broadcast instruction is received, and obtain the identifier of each of the inverters and the identifier of the MPPT branches corresponding to the inverter returned from the inverter with a delay of a second return time since the broadcast instruction is received.

The first return time is determined by the tracker using a first random function after receiving the broadcast instruction. Different trackers correspond to a same value or different values of the first return time.

The second return time is determined by the inverter using a second random function after receiving the broadcast instruction. Different inverters correspond to a same value or different values of the first return time.

The first return time and the second return time are different from each other but are both random.

In an example, the controller sends the broadcast instruction to each of the trackers and the inverters in the photovoltaic power station, and the broadcast instruction carries an instruction requesting a photovoltaic device to return its identifier. That is, each tracker is required to send its identifier to the controller in response to the broadcast instruction, and each inverter is required to send its identifier, together with identifiers of any MPPT branch connected to the inverter, to the controller in response to the broadcast instruction.

The following solution is adopted in order to ensure, as much as possible, that the multiple trackers and the multiple inverters return their identifiers at different time instants from each other, so as to avoid communication congestion caused by all photovoltaic devices uploading their identifiers simultaneously. After receiving the broadcast instruction, each of the trackers determines a first return time Δt1 using a first random function, and returns its identifier after waiting for the first return time Δt1. Values of the first return time Δt1 determined by the trackers may be the same or different, as long as avoiding multiple trackers returning their identifiers simultaneously.

Similarly, after receiving the broadcast instruction, each of the inverters determines a second return time Δt2 using a second random function, and return its identifier after waiting for the second return time Δt2. Values of the second return time Δt2 determined by the inverters may be the same or different, as long as avoiding multiple inverters returning their identifiers simultaneously.

Similarly, the first return time Δt1 and the second return time Δt2 should be different from each other, so as to realize that the trackers and the inverters return their identifiers at different time instants.

It should be noted that there are various types of preset action instructions sent to the target trackers, and the actions corresponding to different preset action instructions are different from each other. Therefore, the expected MPPT branch changes are also different. Reference may be made to the method embodiments for details, which are repeated here.

To further optimize the above embodiments, the instruction sending unit 202 may include a selection subunit and a first action instruction sending subunit.

The selection subunit is configured to: determine trackers in a quantity of p from the photovoltaic power station as target trackers, and determine preset action instructions in a quantity of p, where the preset action instructions carry information of different actions, and p is a positive integer.

The first action instruction sending subunit is configured to send, to each of the target trackers, one of the p preset action instructions containing the identifier of the target tracker, to instruct the target tracker to act in response to the preset action instruction.

To further optimize the above embodiment, the instruction sending unit 202 may further include an action instruction determination subunit, a dividing subunit, and a second action instruction sending subunit.

The action instruction determination subunit is configured to determine preset action instructions in a quantity of n. The preset action instructions carry information of different actions and each includes at least one tracker identifier. The n preset action instructions include m tracker identifiers in total, where m>n, and m represents a total quantity of trackers in the photovoltaic power station, 1<n<Nₘₐₓ, and Nₘₐₓ represents a maximum quantity of available preset action instructions.

The dividing subunit is configured to divide the trackers in the photovoltaic power station in a way that the target trackers corresponding to a same preset action instruction are in a same group, to obtain tracker groups in a quantity of n.

The second action instruction sending subunit is configured to send, to each of the target trackers in each of the tracker groups, one of the p preset action instructions containing the identifier of the target tracker, to instruct the target tracker to act in response to the preset action instruction. Actions instructed by the preset action instructions sent to target trackers in a same tracker group are different from each other.

It should be noted that reference may be made to the method embodiments for detailed principles of the components in the apparatus embodiments, which are not described in detail here.

It should be noted that the relationship terminologies such as first, second or the like are used herein to distinguish one entity or operation from another, rather than to necessitate or imply an actual relationship or order among the entities or operations. Furthermore, terms “include”, “comprise” or any other variants are intended to cover the non-exclusive inclusion. Therefore, a process, method, article or device including a series of elements is not necessarily limited to those expressly listed steps or units, but may include other elements not expressly listed or inherent to the process, method, article, or device. Unless expressively limited otherwise, a statement “comprising (including) a (an) . . . ” does not exclude existence of another similar element in the process, method, article or device.

The embodiments are described in this specification in a progressive manner. Various embodiments may refer to each other for the same or similar parts, and each embodiment places emphasis on the difference from other embodiments.

The description of the embodiments herein enables those skilled in the art to implement or use the present disclosure. Many modifications to these embodiments are apparent for those skilled in the art. The general principles defined herein may be applied to other embodiments without departing from the spirit or scope of the present disclosure. Therefore, the present disclosure is not limited to the embodiments illustrated herein, but is to conform to the widest scope consistent with the principles and novel features disclosed herein.

1. A method for matching between photovoltaic devices, applicable to a controller of a photovoltaic tracking system, wherein the method comprises:
acquiring identifiers of trackers in a photovoltaic power station, identifiers of inverters in the photovoltaic power station, and identifiers of maximum power point tracking, MPPT, branches in the photovoltaic power station;
sending a preset action instruction to a target tracker, to instruct the target tracker to act in response to the preset action instruction, wherein the target tracker is any one of the trackers in the photovoltaic power station, and the preset action instruction carries the identifier of the target tracker;
obtaining inverter data after sending the preset action instruction, wherein the inverter data comprises the identifier of each of the inverters and a changed characteristic of the inverter, and an identifier of each of the MPPT branches and a changed characteristic of the MPPT branch;
determining, based on the inverter data, an identifier of a target MPPT branch of a target inverter that subjects to an expected MPPT branch change, wherein the expected MPPT branch change corresponds to the preset action instruction; and
mapping the target tracker to the identifier of the target MPPT branch.

2. The method according to claim 1, wherein acquiring the identifiers of the trackers in the photovoltaic power station, the identifiers of the inverters in the photovoltaic power station, and the identifiers of the MPPT branches in the photovoltaic power station comprises:
sending a broadcast instruction to the trackers and the inverters in the photovoltaic power station, wherein the broadcast instruction carries an instruction requesting a photovoltaic device to return an identifier of the photovoltaic device; and
obtaining the identifiers of the trackers returned from the trackers after receiving the broadcast instruction, and the identifiers of the inverters and the identifiers of the MPPT branches corresponding to the inverters returned from the inverters after receiving the broadcast instruction.

3. The method according to claim 2, wherein obtaining the identifiers of the trackers returned from the trackers after receiving the broadcast instruction, and the identifiers of the inverters and the identifiers of the MPPT branches corresponding to the inverters returned from the inverters after receiving the broadcast instruction comprises:
obtaining an identifier of each of the trackers returned from the tracker with a delay of a first return time since the broadcast instruction is received, and
obtaining an identifier of each of the inverters and identifiers of the MPPT branches corresponding to the inverter returned from the inverter with a delay of a second return time since the broadcast instruction is received, wherein
the first return time is determined by the tracker using a first random function after receiving the broadcast instruction, and different trackers correspond to a same value or different values of the first return time,
the second return time is determined by the inverter using a second random function after receiving the broadcast instruction, and different inverters correspond to a same value or different values of the first return time, and
the first return time and the second return time are different from each other but are both random.

4. The method according to claim 1, wherein in a case that the preset action instruction is to adjust a tracking bracket to an optimal angle, the expected MPPT branch change is an increase of a power or current.

5. The method according to claim 1, wherein in a case that the preset action instruction is to displace a tracking bracket from an optimal inclination angle direction by a preset angle Δθ, the expected MPPT branch change is a decrease of a power or current.

6. The method according to claim 1, wherein in a case that the preset action instruction is to adjust a tracking bracket to a critical angle, the expected MPPT branch change is that a power or current of the MPPT branch becomes the smallest relative to other inverter strings.

7. The method according to claim 1, wherein in a case that the preset action instruction is to repeatedly adjust a tracking bracket to a first preset angle, the expected MPPT branch change is a reciprocating change of a power or current.

8. The method according to claim 1, wherein in a case that the preset action instruction is to adjust a tracking bracket to a second preset angle at a preset rate, the expected MPPT branch change is a rate that a power or current changes.

9. The method according to claim 1, wherein sending the preset action instruction to the target tracker, to instruct the target tracker to act in response to the preset action instruction, comprises:
determining trackers in a quantity of p from the photovoltaic power station as target trackers, and determining preset action instructions in a quantity of p, wherein the preset action instructions carry information of different actions, and p is a positive integer; and
sending, to each of the target trackers, one of the p preset action instructions containing the identifier of the target tracker, to instruct the target tracker to act in response to the preset action instruction.

10. The method according to claim 1, wherein sending the preset action instruction to the target tracker, to instruct the target tracker to act in response to the preset action instruction, comprises:
determining preset action instructions in a quantity of n, wherein the preset action instructions carry information of different actions and an identifier of at least one tracker, and the preset action instructions include identifiers of m trackers, where m>n, and m represents a total quantity of trackers in the photovoltaic power station, 1<n<Nₘₐₓ, and Nₘₐₓ represents a maximum quantity of available preset action instructions;
dividing the trackers in the photovoltaic power station in a way that the target trackers corresponding to a same preset action instruction are in a same group, to obtain tracker groups in a quantity of n; and
sending, to each of the target trackers in each of the tracker groups, one of the preset action instructions containing the identifier of the target tracker, to instruct the target tracker to act in response to the preset action instruction, wherein actions instructed by the preset action instructions sent to target trackers in a same tracker group are different from each other.

11. An apparatus for matching between photovoltaic devices, applicable to a controller of a photovoltaic tracking system, wherein the apparatus comprises:
one or more processors; and
a memory configured to store one or more programs, wherein
the one or more programs, when executed by the one or more processors, cause the one or more processors to:
acquire identifiers of trackers in a photovoltaic power station, identifiers of inverters in the photovoltaic power station, and identifiers of maximum power point tracking, MPPT, branches in the photovoltaic power station;
send a preset action instruction to a target tracker, to instruct the target tracker to act in response to the preset action instruction, wherein the target tracker is any one of the trackers in the photovoltaic power station, and the preset action instruction carries the identifier of the target tracker;
obtain inverter data after sending the preset action instruction, wherein the inverter data comprises the identifier of each of the inverters and a changed characteristic of the inverter, and an identifier of each of the MPPT branches and a changed characteristic of the MPPT branch;
determine, based on the inverter data, an identifier of a target MPPT branch of the target inverter that subjects to an expected MPPT branch change, wherein the expected MPPT branch change corresponds to the preset action instruction; and
map the target tracker to the identifier of the target MPPT branch.

12. The apparatus according to claim 11, wherein the one or more programs, when executed by the one or more processors, further cause the one or more processors to:
send a broadcast instruction to the trackers and the inverters in the photovoltaic power station, wherein the broadcast instruction carries an instruction requesting a photovoltaic device to return an identifier of the photovoltaic device; and
obtain the identifiers of the trackers returned from the trackers after receiving the broadcast instruction, and the identifiers of the inverters and the identifiers of the MPPT branches corresponding to the inverters returned from the inverters after receiving the broadcast instruction.

13. The apparatus according to claim 11, wherein the one or more programs, when executed by the one or more processors, further cause the one or more processors to:
determine trackers in a quantity of p from the photovoltaic power station as target trackers, and determine preset action instructions in a quantity of p, wherein the preset action instructions carry information of different actions, and p is a positive integer; and
send, to each of the target trackers, one of the p preset action instructions containing the identifier of the target tracker, to instruct the target tracker to act in response to the preset action instruction.

14. The apparatus according to claim 11, wherein the one or more programs, when executed by the one or more processors, further cause the one or more processors to:
determine preset action instructions in a quantity of n in total, wherein the preset action instructions carry information of different actions and an identifier of at least one tracker, and the preset action instructions include identifiers of m trackers, where m>n, and m represents a total quantity of trackers in the photovoltaic power station, 1<n<Nₘₐₓ, and Nₘₐₓ represents a maximum quantity of available preset action instructions;
divide the trackers in the photovoltaic power station in a way that the target trackers corresponding to a same preset action instruction are in a same group, to obtain tracker groups in a quantity of n; and
send, to each of the target trackers in each of the tracker groups, one of the preset action instructions containing the identifier of the target tracker, to instruct the target tracker to act in response to the preset action instruction, wherein actions instructed by the preset action instructions sent to target trackers in a same tracker group are different from each other.

15. A photovoltaic tracking system, comprising photovoltaic modules, trackers, inverters and a controller, wherein
the controller is communicatively connected with the trackers and the inverters, each of the trackers is mechanically coupled to at least one of the photovoltaic modules, and at least one of the photovoltaic modules is connected to a direct current side of one of the inverters; and
the controller comprises:
one or more processors; and
a memory configured to store one or more programs, wherein
the one or more programs, when executed by the one or more processors,
cause the one or more processors to:
acquire identifiers of the trackers, identifiers of the inverters, and identifiers of maximum power point tracking, MPPT, branches of the inverters;
send a preset action instruction to a target tracker, to instruct the target tracker to act in response to the preset action instruction, wherein the target tracker is any one of the trackers, and the preset action instruction carries the identifier of the target tracker;
obtain inverter data after sending the preset action instruction, wherein the inverter data comprises the identifier of each of the inverters and a changed characteristic of the inverter, and an identifier of each of the MPPT branches and a changed characteristic of the MPPT branch;
determine, based on the inverter data, an identifier of a target MPPT branch of the target inverter that subjects to an expected MPPT branch change, wherein the expected MPPT branch change corresponds to the preset action instruction; and
map the target tracker to the identifier of the target MPPT branch.
